(19) United States
(12) Patent Application Publication
(10) Pub. No.: US 2005/0242099 A1
(43) Pub. Date: Nov. 3, 2005

(54) Dual purpose baking pan

(76) Inventor: William E. Berryhill, South Pittsburg, TN (US)

Correspondence Address: J.W. Gipple;Gipple and Hale, P.O. Box 40513, Washington, DC, 20016, US

(21) Appl. No.: 10/834,208

(22) Filed: Apr. 29, 2004

(51) Int. Cl. A23P 1/00

(52) U.S. Cl. 220/573.1

(57) ABSTRACT

A baking pan for producing edible cups, which is a single integrated unit and which can be inverted to serve as a muffin pan.

### FIELD OF THE INVENTION

This invention is directed to a baking pan or molds for producing edible cornbread cups, which said baking pan comprises a single integrated unit and can be inverted to serve as a muffin pan.

### BACKGROUND OF THE INVENTION

It has long been understood and appreciated that containers for foods can, themselves, be edible. The classic example is the ice cream cone. One eats the cone, as well as the ice cream; there is nothing to discard. Furthermore, the crunchy texture of the cone is a pleasant counterpart to the smooth, dense texture of the ice cream. The edible container for foods is not only convenient and efficient, but can also enhance appreciation for the contained food.

Many foods such as beans or chili, which are often served with cornbread, can be enhanced by being offered in a container formed of cornbread. In the past, such cornbread containers have been formed by using molds with multiple parts and/or wire fasteners to hold them together while the bread is baking. Such molds are expensive to produce and awkward to handle.

It is, therefore, an object of the present invention to provide a baking pan for producing cornbread cups that comprises a single, all-inclusive unit. A further object is provide such a baking pan, that is designed to produce a cornbread cup which is evenly baked through its entirety, with no surface or interior over baked or under baked.

It is a further object of this invention to provide a baking pan, as described above, which when inverted, can be used as a muffin pan to which also produce muffins that are evenly baked through their entirety with no hot spots.

### BRIEF DESCRIPTION OF THE DRAWINGS

FIG. 1 is a perspective view of the pan with four individual cornbread cup molds.

FIG. 2 is a cross sectional view of an individual cornbread cup mold.

### DESCRIPTION OF THE PREFERRED EMBODIMENT

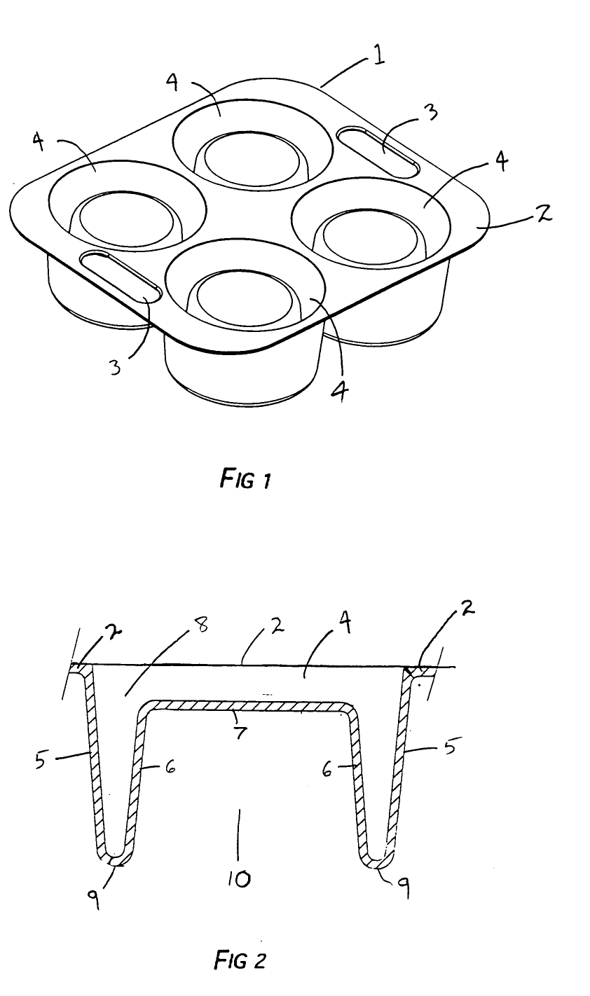

The following provides an explanation of the preferred embodiment of the present invention as illustrated in FIGS. 1 and 2. The pan is made of cast iron.

Referring to FIG. 1, the pan 1 comprises four individual cup molds 4, which extend below the top sheet 2. Apertures 3 are formed toward the opposite ends of top sheet 2. The apertures 3 facilitate handling and lifting of the pan.

Referring to FIG. 2, an individual cup mold 4 is illustrated as comprising an outer wall 5 which extends downwardly from the top sheet 2. The cup mold bottom 9 is formed, as the cast iron of outer wall 5, curves back on itself and extends upwardly to form the inner wall 6. The top of cup mold 7, extends horizontally between the top ends of inner wall 6. The cup mold cavity 8 is formed between outer wall 5 and inner wall 6; and above the top of the cup mold 7.

To produce a cornbread cup, batter is poured into the cavity 8, to a level slightly below top sheet 2. Everywhere the batter touches the cast iron it becomes brown and forms crust which defines the corn bread cup.

The dual function of this baking pan 1 is in that it can be inverted and placed on a cookie sheet or other such horizontal support (not illustrated in the drawings). In this position, the cup mold bottom 9 is at the top of muffin cup cavity 10. The cup mold top 7 is at the bottom of muffin cup cavity 10.

To produce a muffin, batter is poured into the muffin cup cavity 10 to a level slightly below that of cup mold bottom 9. It will be appreciated that the muffin cup cavity 10 is raised above its horizontal support, so there is a void between the cup mold top 7 and the horizontal support. There is also a void between the inner wall 6 and the outer wall 5. These voids serve to insulate the muffin cup cavity 10, so that hot air can encircle the muffin pan cavity without hot spots on the bottom or sides.

While a particular embodiment of the present invention has been illustrated and described, it will be obvious to those skilled in the art that changes and modifications may be made without departing from the spirit of this invention in its broader aspects and, therefore, the aim of the appended claims is to cover all such changes and modifications as fall within the true spirit and scope of this invention.

1. A baking pan for producing edible cups comprising:
a top sheet
one or more cup mold which extend below the top sheet
each cup mold including an inner wall and an outer wall having a void between them and joined at their bottom ends, and a top which extends between the sides of the said inner wall at a level lower than the said top sheet

2. The baking pan of claim 1, wherein it comprises a single integrated unit

3. The baking pan of claim 2, wherein it is formed of cast iron

4. The baking pan of claim 1, that can be inverted to serve as a muffin pan
